(19) United States
(12) Patent Application Publication
(10) Pub. No.: US 2025/0242298 A1
(43) Pub. Date: Jul. 31, 2025

(54) SYSTEM AND METHOD OF PHASE SEPARATION FOR ABSORPTION COLUMN

(71) Applicant: NUOVO PIGNONE TECNOLOGIE S.r.l., Florence (IT)

(72) Inventor: Augusta Pedacchia, Sezze (Lt) (IT)

(21) Appl. No.: 18/428,675

(22) Filed: Jan. 31, 2024

(51) Int. Cl. B01D 53/18; B01D 53/14

(52) U.S. Cl. CPC B01D 53/18; B01D 53/1425; B01D 53/1475

(57) ABSTRACT

A system includes an absorption column configured to receive a lean solvent and an input gas with a feed gas or a feed vapor therein and induce co-current flow of the lean solvent and the input gas therethrough to form a mixture of a rich solvent with the feed gas or the feed vapor absorbed therein and the input gas with the feed gas or the feed vapor at least partially removed, and a post-absorption column processing assembly disposed downstream of the absorption column. The post-absorption column processing assembly includes a vessel configured to receive a single stream of the mixture from the absorption column and separate the mixture into gas and liquid, a first stream with a predominantly liquid phase of the mixture from the absorption column and separate gas therefrom, or a second stream of a predominantly gaseous phase of the mixture and separate the liquid therefrom.

### BACKGROUND

Various manufacturing and chemical systems, e.g., oil refineries, produce flue gases including carbon dioxide. While the flue gases from these systems may be exhausted out of the systems, it is desirable to remove the carbon dioxide from the flue gases prior to exhausting out of the systems. Such removal is referred to as carbon capture. Improvements to carbon capture systems that perform carbon capture may be desirable.

### SUMMARY

An embodiment of a system, including an absorption column configured to receive a lean solvent and an input gas with a feed gas or a feed vapor therein and induce co-current flow of the lean solvent and the input gas therethrough to form a mixture of a rich solvent with the feed gas or the feed vapor absorbed therein and the input gas with the feed gas or the feed vapor at least partially removed, and a post-absorption column processing assembly disposed downstream of the absorption column, wherein the post-absorption column processing assembly comprises a vessel configured to receive i) a single stream of the mixture from the absorption column and separate the mixture into gas and liquid, ii) a first stream with a predominantly liquid phase of the mixture from the absorption column and separate gas therefrom, or iii) a second stream of a predominantly gaseous phase of the mixture and separate the liquid therefrom.

An embodiment of a system, including an absorption column configured to receive a lean solvent and an input gas with a feed gas or a feed vapor therein and induce co-current flow of the lean solvent and the input gas therethrough to form a mixture of a rich solvent with the feed gas or the feed vapor absorbed therein and the input gas with the feed gas or the feed vapor at least partially removed, a post-absorption column processing assembly disposed downstream of the absorption column, a stripper column disposed downstream of the post-absorption column and at least a reboiler, a condenser, and a reflux drum connected to the stripper column, the stripper column, the reboiler, the condenser, and the reflux drum configured to separate rich solvent received from the post-absorption column processing assembly into lean solvent and the compound, and a solvent tank disposed downstream of the stripper column and configured to feed the lean solvent to the absorption column, wherein the post-absorption column processing assembly comprises a vessel configured to receive i) a single stream of the mixture from the absorption column and separate the mixture into gas and liquid, ii) a first stream with a predominantly liquid phase of the mixture from the absorption column and separate gas therefrom, or iii) a second stream of a predominantly gaseous phase of the mixture and separate the liquid therefrom.

An embodiment of a method for operating a system, including feeding a lean solvent and input gas comprising a compound into an absorption column of the system, inducing co-current flow of the lean solvent and the input gas through the absorption column to form a mixture of rich solvent with the compound absorbed therein and the input gas with the compound at least partially removed, the post-absorption column processing assembly comprises a vessel configured to receive i) a single stream of the mixture from the absorption column and separate the mixture into gas and liquid, ii) a first stream with a predominantly liquid phase of the mixture from the absorption column and separate gas therefrom, or iii) a second stream of a predominantly gaseous phase of the mixture and separate the liquid therefrom, feed into a first vessel the mixture or a predominantly liquid phase of the mixture to separate the mixture or the predominantly liquid phase into liquid and gas, and feed the liquid from the first vessel into a stripper column of the carbon capture system and feed the gas from the first vessel into the second vessel.

### BRIEF DESCRIPTION OF THE DRAWINGS

The following descriptions should not be considered limiting in any way. With reference to the accompanying drawings, like elements are numbered alike:

FIG. 1 shows a simplified schematic diagram of a carbon capture system according to one or more embodiments;

FIG. 2 is a view of a corrugated screen packing module according to one or more embodiments:

FIG. 3A is a schematic diagram of a first vessel according to one or more embodiments;

FIG. 3B is a schematic diagram of a first vessel according to one or more embodiments;

FIG. 4A is a schematic diagram of a second vessel according to one or more embodiments;

FIG. 4B is a schematic diagram of a second vessel according to one or more embodiments;

FIG. 5 shows a simplified schematic diagram of a post-absorption column processing assembly according to one or more embodiments; and

FIG. 6 shows a flow chart of a process of phase separation for an absorption column with a corrugated screen packing assembly according to one or more embodiments.

### DETAILED DESCRIPTION

A detailed description of one or more embodiments of the disclosed apparatus and method are presented herein by way of exemplification and not limitation with reference to the Figures.

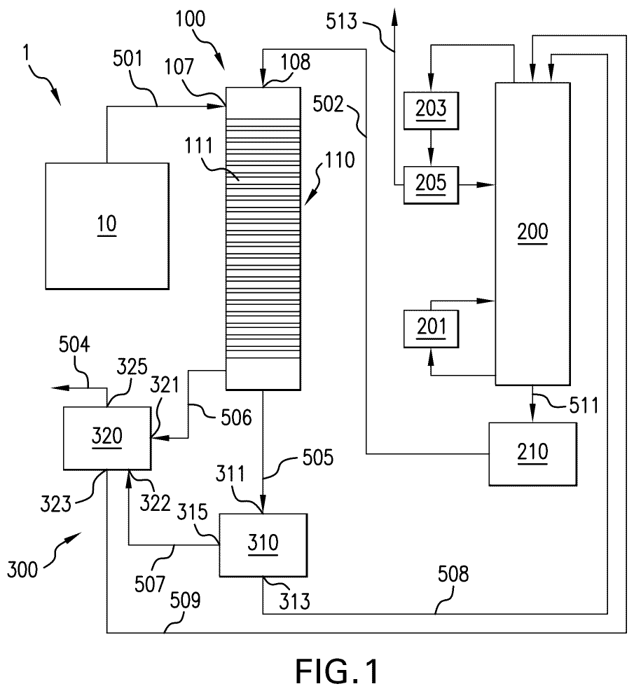

A simplified schematic diagram of a carbon capture system 1 according to one or more embodiments is shown in FIG. 1. The carbon capture system 1 may include a manufacturing or chemical system 10 that produces flue gases that it is desirable to capture rather than release to the environment. The flue gases may be output from an outlet of the manufacturing or chemical system 10. Such gases include carbon dioxide, nitrogen, sulfur dioxide, and carbon monoxide, for example. The manufacturing or chemical system 10 may be of any type including but not limited to an oil refinery.

The carbon capture system 1 may further include an absorption column 100. The absorption column 100 may be a regenerative froth contactor (RFC) equipped with a corrugated screen packing assembly 110 that includes a plurality of corrugated screen packing modules 111.

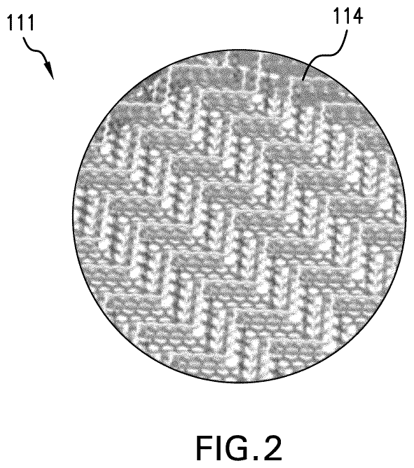

A non-limiting example of a corrugated screen packing module 111 is shown in FIG. 2. The corrugated screen packing module 111 may be formed of a plurality of corrugated structures 114. The corrugated screen packing modules 111 may further include other structures such as grid layers, support structures to support the corrugated screen packing module and/or components thereof, and/or a mounting structure for mounting the corrugated screen packing module 111 on an outer wall of the absorption column 100.

An input gas line 501 may extend from an outlet of the manufacturing or chemical system 10 to an input gas inlet 107 of the absorption column 100. The input gas inlet 107 may be disposed at or near an upstream portion of the absorption column 100. The input gas inlet 107 may be disposed upstream of an entirety of the corrugated screen packing assembly 110.

The carbon capture system 1 may further include a solvent tank 210. The solvent tank 210 may store a liquid solvent. The liquid solvent may be amine, amino acid salts, carbonate systems, aqueous ammonia, immiscible liquids, ionic liquids, or another liquid solvent known in the art effective for carbon capture. As explained below, the liquid solvent within the solvent tank 210 may be a lean liquid solvent. A lean solvent line 502 may extend from a lean solvent outlet of the solvent tank 210 to a lean solvent inlet 108 of the absorption column 100. The lean solvent inlet 108 may be disposed at or near an upstream portion of the absorption column 100. The lean solvent inlet 108 is disposed upstream of an entirety of the corrugated screen packing assembly 110.

As explained above, the input gas inlet 107 and the lean solvent inlet 108 may be disposed at or near an upstream portion of the absorption column 100 upstream of the corrugated screen packing assembly 110. As such, the absorption column 100 may induce co-current flow of the input gas from the glue gas inlet 107 and the lean solvent from the lean solvent inlet 108 downstream through the corrugated screen packing assembly 110. That is, the absorption column 100 may include a co-current contactor system in the form of the corrugated screen packing assembly 110. The co-current flow of the input gas and the lean solvent through the corrugated screen packing assembly 110 results in carbon dioxide in the input gas being absorbed into the solvent, removing the carbon dioxide from the input gas and forming a rich solvent having carbon dioxide absorbed therein.

The input gas and the lean solvent fed into the absorption column 100 may travel downstream in a gas-liquid co-flow configuration, with a pulse regime hydrodynamic condition. Each of the corrugated screen packing modules 111 may be formed of convoluted screens that maximize the solvent pulsing effect while minimizing the metal packing material. The corrugated screen packing assembly 110 may induce the absorption column 100 to operate under a froth condition in two-phase flow with millions of bubbles and droplets being formed in the absorption column 100. The bubbles may be created as bands of froth collapse and are regenerated. The lean solvent in liquid phase and the input gas in gaseous phase may be fed into the absorption column co-currently from the upstream portion, flow through corrugated screen packing assembly 110 in pulsing regime and disengage at the downstream portion of the absorption column 100. The pulse flow may occur due to a hydrodynamic multi-phase phenomenon depending on the flow rates and the design of the corrugated screen packing assembly 110. The gas may pass through multiple zones of froth along the corrugated screen packing assembly 110, and the carbon dioxide may get absorbed into the lean solvent.

An absorption column 100 according to one or more embodiments may enable accommodation of high gas flow rates and liquid/gas ratios, without excessive back pressure or flooding within the absorption column 100. The absorption column 100 may also be used in processes with precipitating solvents or high levels of entrained solids, leading to three-phase contactors. The absorption column 100 may experience minimal or no fouling or additional pressure drop penalty, even under high particulate loads and high viscosity.

The absorption column 100 may include a liquid phase outlet and a gaseous phase outlet.

It was discovered that, because the corrugated screen packing assembly 110 may create extreme turbulence to induce heavy mixing of the input gas and the solvent and form a frothy liquid, separation of the liquid phase and the gaseous phase in the absorption column 100 may result in a predominantly liquid phase that still contains some gaseous components, and a predominantly gaseous phase that still contains some liquid components. That is, the absorption column 100 may separate the mixture as a prevalently liquid phase with some carried over gas and a prevalently gas phase with entrained liquid.

The carbon capture system 1 may further include a post-absorption column processing assembly 300. The post-absorption column processing assembly 300 may include a first vessel 310 and a second vessel 320. The first vessel 310 may be a vapor-liquid separator or a liquid degassing vessel, and the second vessel 320 may be a vapor-liquid separator or a gas disengagement vessel.

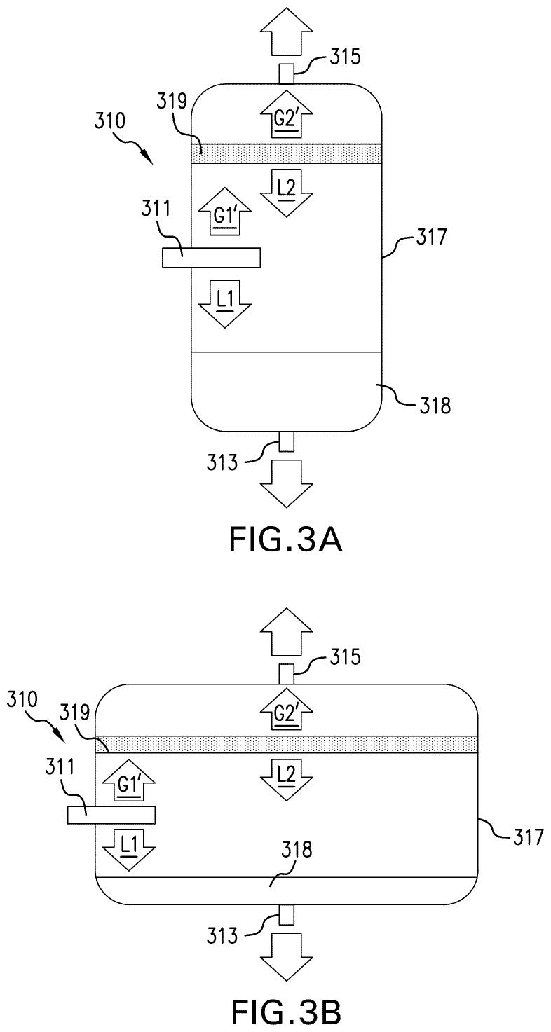

A non-limiting example of a first vessel 310 is shown in FIGS. 3A and 3B. The first vessel 310 may define a first direction and a second direction. The first direction may be an upward direction and the second direction may be a downward direction, but the present disclosure is not limited thereto. The first vessel 310 may include a liquid phase inlet 311, and a liquid phase line 505 may connect the liquid phase inlet 311 of the first vessel 310 to the liquid phase outlet of the absorption column 100. The first vessel 310 may include a housing 317. The first vessel 310 may include a mesh layer 319 in the first direction of the liquid phase inlet 311. The first vessel 310 may include a liquid outlet 313 at or near an end portion of the housing 317 in the second direction and a gas outlet 315 at or near an end portion of the housing 317 in the first direction.

A predominantly liquid phase of the mixture may exit the liquid phase outlet of the absorption column 100 and enter the first vessel 310 via the liquid phase line 505, where the mixture may further separate into liquid component L1 and gaseous component G1′. The gaseous component G1′ may include some liquid. The gaseous component G1′ may rise from the liquid phase inlet 311 and pass through the mesh layer 319 to further separate into gaseous component G2′ and liquid component L2. The gaseous component G2′ may include some liquid. The gaseous component G2′ may exit the first vessel 310 through the gas outlet 315. The liquid component L1 from the liquid phase inlet 311 and the liquid component L2 from the mesh layer 319 may fall via gravity and form a pool 318 at an end portion in the second direction of the housing 317. The liquid components L1, L2 may then exit the first vessel 310 from the liquid outlet 313.

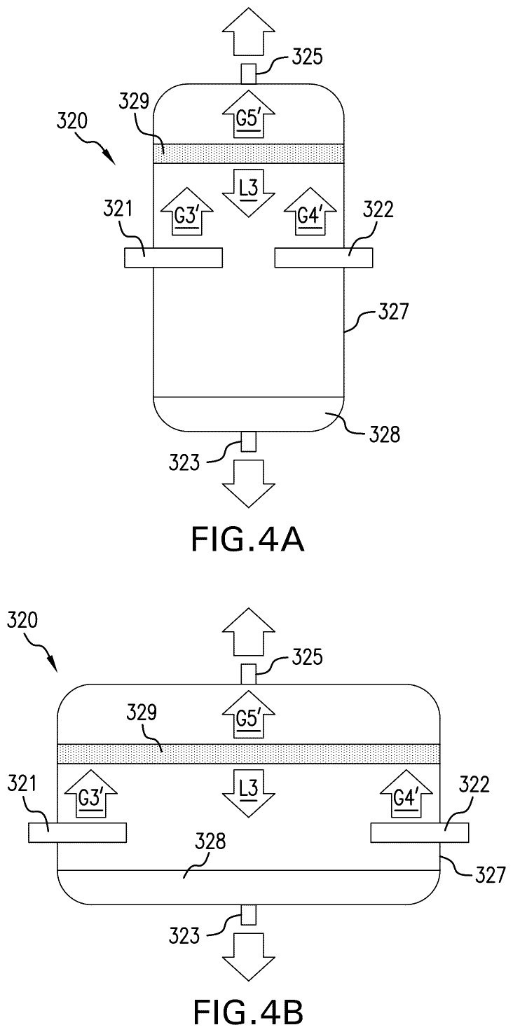

A non-limiting example of a second vessel 320 is shown in FIGS. 4A and 4B. The second vessel 320 may define a first direction and a second direction. The first direction may be an upward direction and the second direction may be a downward direction, but the present disclosure is not limited thereto. The second vessel 320 may include a first gaseous phase inlet 321 and a second gaseous phase inlet 322. A first gaseous phase line 506 may connect the first gaseous phase inlet 321 of the second vessel 320 to the gaseous phase outlet of the absorption column 100, and a second gaseous phase line 507 may connect the second gaseous phase inlet 322 of the second vessel 320 to the gas outlet 315 of the first vessel 310. The second vessel 320 may include a housing 327. The second vessel 320 may include a mesh layer 329 in the first direction of the first gaseous phase inlet 321 and the second gaseous phase inlet 322. The second vessel 320 may include a liquid outlet 323 at or near an end portion of the housing 327 in the second direction and a gas outlet 325 at or near an end portion of the housing 327 in the first direction.

A predominantly gaseous phase of the mixture may exit the gaseous phase outlet of the absorption column 100 and enter the second vessel 320 from the first gaseous phase inlet 321 via the first gaseous phase line 506, and the gas exiting the first vessel 310 through the gas outlet 315 may enter the second vessel 320 from the second gaseous phase inlet 322 via the second gaseous phase line 507. A gaseous component G3′ may rise from the first gaseous phase inlet 321 and a gaseous component G4′ may rise from the second gaseous phase inlet 322 and pass through the mesh layer 329 to separate into gaseous component G5′ and liquid component L3. The gaseous components G3′, G4′, G5′ may include some liquid. The gaseous component G5′ may exit the second vessel 320 through the gas outlet 325. The liquid component L3 from the mesh layer 329 may fall via gravity and form the pool 328 at an end portion of the housing 327 in the second direction. While not shown, the gaseous phase entering the first gaseous phase inlet 321 and/or the gas entering the second gaseous phase inlet 322 may include a liquid component that falls via gravity to the pool 328 at the end portion the housing 327 in the second direction. The liquid component L3 may then exit the second vessel 320 from the liquid outlet 323.

The gaseous component G5′ exiting the second vessel 320 from the gas outlet 325 may be an input gas with carbon dioxide removed therefrom via the absorption column 100, and most or all of the solvent removed therefrom by the absorption column 100, the first vessel 310, and the second vessel 320. The gas outlet 325 of the second vessel may be connected to a gas exhaust line 504. The input gas with carbon dioxide and solvent removed may be removed from the carbon capture system 1 via the gas exhaust line 504. Alternatively, the input gas with carbon dioxide and solvent removed may be exhausted out of the carbon capture system 1 via the gas exhaust line 504.

The liquid components L1, L2, L3 may be a rich solvent that has carbon dioxide from the input gases absorbed therein, but with gaseous components removed therefrom. The liquid outlet 313 of the first vessel 310 may be connected to a first rich solvent line 508, and a liquid outlet 323 of the second vessel 320 may be connected to a second rich solvent line 509.

While a mesh layer 319 for a first vessel 310 and a mesh layer 329 for a second vessel 320 are disclosed above, the first vessel 310 and the second vessel 320 are not limited thereto, and may include other mist eliminating structures.

A post-absorption column processing assembly 300 may allow for desired and controlled grade of gas removal from the liquid phase and liquid removal from the gas phase. The first vessel 310 and the second vessel 320 may be sized based on phase separation criteria of the specific application of the carbon capture system 1.

As noted above, the mixture within the absorption column 100 may be separated as a prevalently liquid phase with some carried over gas and a prevalently gas phase with entrained liquid. A pump (not shown) may be utilized to move the rich solvent to the stripper column 200. However, solvent with excessive gas may cavitate the pumps. A post-absorption column processing assembly 300 according to one or more embodiments removes the gas from the rich solvent in a controlled manner to prevent or minimize such cavitation.

Furthermore, gas with excessive liquid may fail the process separation composition specification, may be environmentally undesirable, and/or may result in loss of solvent through the exhaust. A post-absorption column processing assembly 300 according to one or more embodiments removes the liquid from the gaseous phase in a controlled manner to prevent failure of the process separation composition specification of the carbon capture system 1, reduces or eliminates environmental undesirable exhaust, and/or may reduce loss of solvent.

Additionally, liquid droplets in the gas may damage gas moving systems. A post-absorption column processing assembly 300 according to one or more embodiments may remove the liquid from the gaseous phase in a controlled manner to prevent or minimize such damage.

While FIG. 1 shows a first vessel 310 for removing gas from a liquid phase of the mixture and a second vessel 320 for removing liquid from a gas phase of the mixture, in applications where the absorption column 100 sufficiently removes gas from the liquid phase, the post-absorption column processing assembly 300 may only include the second vessel 320, and in applications where the absorption column 100 sufficiently removes liquid from the gas phase, the post-absorption column processing assembly 300 may only include the first vessel 320.

The carbon capture system 1 may further include a stripper column 200. The stripper column 200 may define a first direction and a second direction. The first direction may be an upward direction and the second direction may be a downward direction, but the present disclosure is not limited thereto. The first rich solvent line 508 may extend from the liquid outlet 313 of the first vessel 310 to a first rich solvent inlet of the stripper column 200, and the second rich solvent line 509 may extend from the liquid outlet 323 of the second vessel 320 to a second rich solvent inlet of the stripper column 200. Alternatively, the first rich solvent line 508 and the second rich solvent line 509 may be combined into a single rich solvent line that extends to a single rich solvent inlet of the stripper column 200.

The first rich solvent inlet and the second rich solvent inlet or the single rich solvent inlet of the stripper column 200 may be at or near an end portion of the stripper column 200 in the first direction. The rich solvent may be moved from the liquid outlet 313 of the first vessel 310 via the first rich solvent line 508 and the liquid outlet 323 of the second vessel 320 via the second rich solvent line 509 and fed into the first rich solvent inlet and the second rich solvent inlet or the single rich solvent inlet of the stripper column 200. The rich solvent may be pumped to the stripper column 200. The rich solvent may be heated, for example by a heat exchanger, prior to being fed into the stripper column 200. The carbon capture system 1 may further include a solvent line 511 extending from a solvent outlet of the stripper column 200 to a solvent inlet of the solvent tank 210.

The stripper column 200 may be a stripper column known in the art for separating carbon dioxide from a rich solvent containing carbon dioxide. As a non-limiting example, the stripper column 200 may include packing material (not shown), while at least a reboiler 201, a condenser 203, and a reflux drum 205 may be connected to the stripper column 200. The rich solvent fed into the rich solvent inlet of the stripper column 200 may fall due to gravity over the packing material to an end portion of the stripper column 200 in the second direction where the solvent may be fed into the reboiler 201. While FIG. 1 shows a separate line from the solvent line 511 feeding into the reboiler 201, the line feeding into the reboiler 201 may branch from the solvent line 511. The reboiler 201 may heat the solvent such that water in the solvent is turned steam and fed back into the stripper column 200. The steam and the carbon dioxide may rise to an end portion of the stripper column 200 in the first direction and run through the condenser 203 where the steam and carbon dioxide are cooled to form liquid water and gaseous carbon dioxide and fed into the reflux drum 205. The water may be fed from the reflux drum 205 back into the stripper column 200 and mixed with the solvent at the end portion of the stripper column 200 in the second direction and/or at the solvent tank 210. Thus, lean solvent may be fed into the solvent tank 210 and subsequently cycled back into the absorption column 100 as explained above. The gaseous carbon dioxide may be removed from the reflux drum 205 via a carbon dioxide line 513. The gaseous carbon dioxide may then be cooled into liquid and stored and/or used in other applications.

While a non-limiting example of an oil refinery is mentioned above for the manufacturing or chemical system 10, the carbon capture system 1 may be applicable to various carbon capture platforms including, for example, natural gas treatment, post-combustion capture, air pollution control, indoor air quality management, and direct air capture.

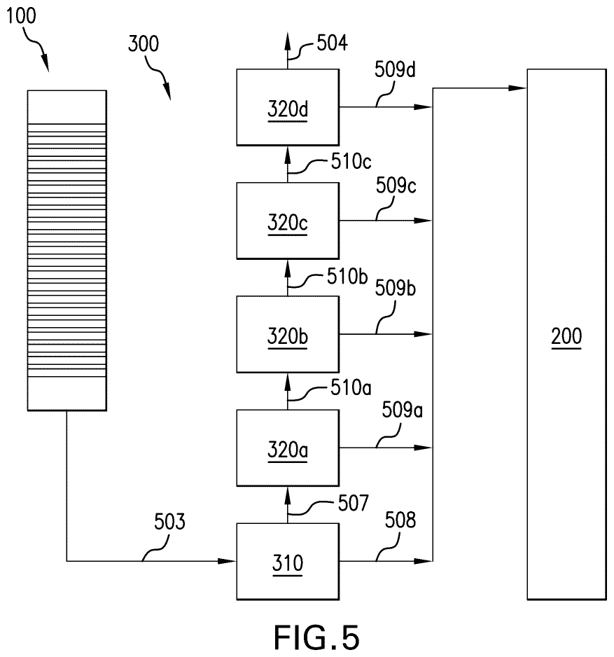

A post-absorption column processing assembly 300 according to one or more embodiments is shown in FIG. 5. An absorption column 100 may include only a single outlet that feeds a mixture of the input gas with the carbon dioxide removed and the rich solvent with the carbon dioxide absorbed therein (“the mixture”) to the post-absorption column processing assembly 300. The mixture may be moved from the absorption column 100 through the mixture line 503 to a first vessel 310 of the post-absorption column processing assembly 300. The post-absorption column processing assembly 300 shown in FIG. 5 is similar to that shown in FIG. 1 and the first vessel 310 thereof may be similar to the first vessel 310 shown in FIGS. 1 and 3. However, instead of a single second vessel 320 to process the gas exiting the first vessel 310 shown in FIG. 1, the post-absorption column processing assembly 300 may include a plurality of vessels to do so. The post-absorption column processing assembly 300 may include, for example, a second vessel 320a, a third vessel 320b, a fourth vessel 320c, and a fifth vessel 320d. However, the five vessels shown in FIG. 5 are not limiting in any way, and the post-absorption column processing assembly 300 may include three vessels, four vessels, six vessels, etc., as appropriate to sufficiently remove liquid from the input gas exiting the absorption column 100.

The second vessel 320a, the third vessel 320b, the fourth vessel 320c, and the fifth vessel 320d may be similar to the second vessel 320 shown in FIGS. 1 and 4.

The second vessel 320a may receive the gas exiting the first vessel 310 and separate liquid droplets from the gas via a second gaseous phase line 507. The separated gas from the second vessel 320a may be received by the third vessel 320b via a third gaseous phase line 510a and the separated liquid from the second vessel 320a is received by the stripper column 200 via a second rich solvent line 509a.

The third vessel 320b may separate liquid droplets from the gas received from the second vessel 320a. The separated gas from the third vessel 320b may be received by the fourth vessel 320c via a fourth gaseous phase line 510b and the separated liquid from the third vessel 320b may be received by the stripper column 200 via a third rich solvent line 509b.

The fourth vessel 320c may separate liquid droplets from the gas received from the third vessel 320b. The separated gas from the fourth vessel 320c may be received by the fifth vessel 320d via a fifth gaseous phase line 510c and the separated liquid from the fourth vessel 320c may be received by the stripper column 200 via a fourth rich solvent line 509c.

The fifth vessel 320d may separate liquid droplets from the gas received from the fourth vessel 320c. The separated liquid from the fifth vessel 320d may be received by the stripper column 200 via a fifth rich solvent line 509d. The separated gas from the fifth vessel 320d, which is input gas with the carbon dioxide and solvent removed, may be removed from the carbon capture system 1 via a gas exhaust line 504. Alternatively, the input gas with the carbon dioxide and solvent removed may be exhausted out of the carbon capture system 1 via the gas exhaust line 504.

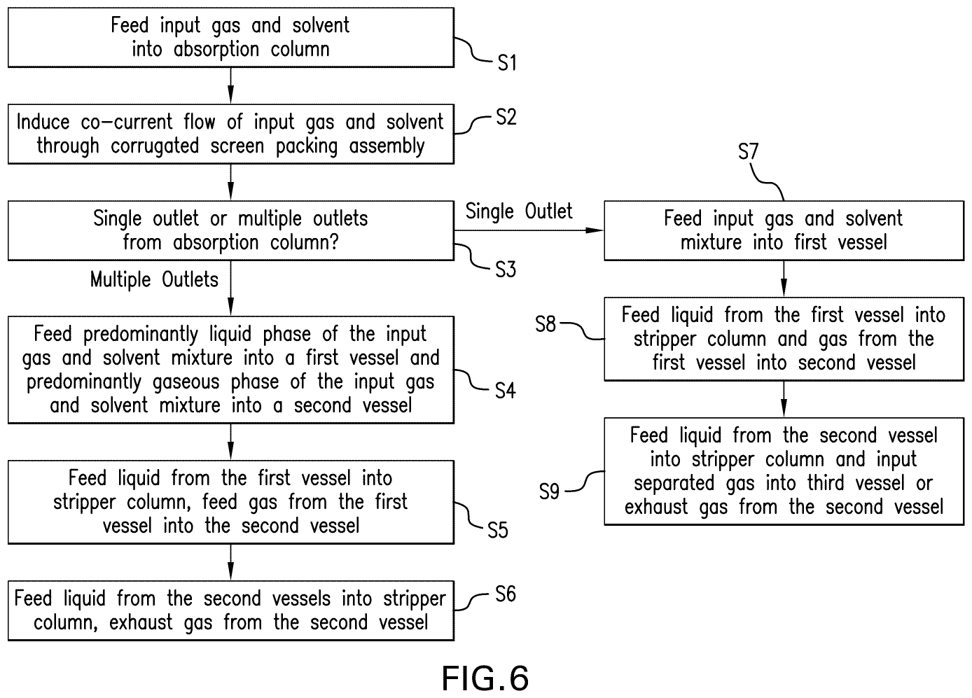

A process of absorption and post-absorption processing according to one or more embodiments is shown in FIG. 6. In Step S1, input gas containing a feed gas or a feed vapor and lean solvent is fed into an absorption column 100. The feed gas for feed vapor may be, for example, carbon dioxide from direct capture or a manufacturing or chemical system 10. However, the feed gas or feed vapor is not limited thereto. The lean solvent may be from a solvent tank 210 or from another source.

In Step S2, the absorption column 100 may induce co-current flow of the input gas and the lean solvent through a corrugated screen packing assembly 110 of the absorption column 100 to form a mixture of rich solvent having the feed gas or feed vapor absorbed therein and input gas having the feed gas or feed vapor removed therefrom (“the mixture”).

In Step S3, if the absorption column 100 has multiple outlets such that there are separate outlets for a liquid phase the mixture and a gaseous phase of the mixture, the process moves to step S4.

In Step 4, the absorption column 100 may separate the mixture into a predominantly liquid phase that contains mostly rich solvent containing the feed gas or vapor and a predominantly gaseous phase that contains mostly input gas from which feed gas or vapor has been removed, and feed the predominantly liquid phase into a first vessel 310 of a post-absorption column processing assembly 300, and the predominantly gaseous phase from the absorption column 100 is fed into a second vessel 320 of a post-absorption column processing assembly 300. As noted above, the predominantly liquid phase may still contain some gas, and the predominantly gaseous phase may still contain some liquid.

In Step S5, the first vessel 310 may remove gas from the liquid phase and the liquid is fed into a stripper column 200 while the separated gas is fed into the second vessel 320. The separated gas may still contain some liquid.

In step S6, the second vessel 320 may remove liquid from the gaseous phase and the gas may be exhausted while the separated liquid is fed into the stripper column 200. Steps S5 and S6 may occur concurrently and/or continuously. The gas exhausted from the second vessel may be removed from post-absorption column processing assembly 300.

In Step S3, if the absorption column 100 has a single outlet for the mixture, the process moves to step S7.

In Step S7, the mixture is fed from the absorption column 100 into a first vessel 310 of a post-absorption column processing assembly 300.

In Step S8, the first vessel 310 may separate the mixture into a liquid phase and a gaseous phase, and the liquid is fed into a stripper column 200 while the separated gaseous phase is fed into the second vessel 320. The separated gas may still contain some liquid.

In step S9, the second vessel 320A may remove liquid from the gaseous phase and the separated liquid is fed into the stripper column 200, while the separated gaseous phase may either be fed into a third vessel 320B or exhausted. Step S9 may be repeated until liquid is sufficiently removed from the gaseous phase, for example, if the separated gaseous phase is fed into the third vessel, step S9 may be repeated and the gaseous phase may be fed into a fourth vessel or exhausted, and so on.

While an absorption column 100 and a post-absorption column processing assembly 300 are described above in the context of a carbon capture system 1, this is merely set forth as an example, and the absorption column 100 and the post-absorption column processing assembly 300 are not limited thereto. That is, the absorption column 100 and the post-absorption column processing assembly 300 may be used in other systems. For example, the absorption column 100 and the post-absorption column processing assembly 300 may be used in a system that removes any other gas or vapor from input gas, including but not limited to corrosive gaseous emissions, acidic fumes, odors, sulfur dioxide, and carbon monoxide. The carbon dioxide and any other gas or vapor removed from the input gas are examples of feed gas or feed vapor.

While the post-absorption column processing assembly 300 in one or more of the above embodiments feeds liquid from the first vessel and the second vessel 320 to the stripper column 200, this is not intended to be limiting. For example, an additional vessel similar to the first vessel 310 may be disposed downstream of the first vessel 310 and/or the second vessel 320 to further separate the liquid from the first vessel 310 and/or the second vessel into liquid and gas if the liquid from the first vessel 310 and/or the second vessel into liquid and gas still contained some gas trapped therein.

Set forth below are some aspects of the foregoing disclosure:

Embodiment 1: A system, including an absorption column configured to receive a lean solvent and an input gas with a feed gas or a feed vapor therein and induce co-current flow of the lean solvent and the input gas therethrough to form a mixture of a rich solvent with the feed gas or the feed vapor absorbed therein and the input gas with the feed gas or the feed vapor at least partially removed, and a post-absorption column processing assembly disposed downstream of the absorption column, wherein the post-absorption column processing assembly comprises at least one vessel configured to receive i) at least a single stream of the mixture from the absorption column and separate the mixture into gas and liquid, ii) a first stream with a predominantly liquid phase of the mixture from the absorption column and separate gas therefrom, or iii) a second stream of a predominantly gaseous phase of the mixture and separate the liquid therefrom.

Embodiment 2: The system as in any prior embodiment, wherein the absorption column comprises a corrugated screen packing assembly.

Embodiment 3: The system as in any prior embodiment, wherein the vessel is a first vessel configured to receive the predominantly liquid phase of the mixture from the absorption column and separate the predominantly liquid phase of the mixture into liquid and gas, and wherein the post-absorption column processing assembly further comprises a second vessel configured to receive the predominantly gaseous phase of the mixture and separate the predominantly gaseous phase of the mixture into gas and liquid.

Embodiment 4: The system as in any prior embodiment, wherein the first vessel is configured to feed the liquid separated from the predominantly liquid phase of the mixture to a stripper column and feed the gas separated from the predominantly liquid phase of the mixture to the second vessel, and wherein the second vessel is configured to feed the liquid separated from the predominantly gaseous phase of the mixture to the stripper column.

Embodiment 5: The system as in any prior embodiment, wherein the absorption column includes a regenerative froth contactor.

Embodiment 6: The system as in any prior embodiment, wherein each of the first vessel and the second vessel comprises a housing, an inlet formed in the housing, a mesh layer, a gas outlet, and a liquid outlet.

Embodiment 7: The system as in any prior embodiment, wherein the second vessel is configured to receive the gas separated from the predominantly liquid phase of the mixture, and further separate the gas into liquid and gas.

Embodiment 8: The system as in any prior embodiment, wherein the second vessel is configured to feed the liquid separated from the gas separated from the predominantly liquid gas to the stripper column.

Embodiment 9: The system as in any prior embodiment, wherein the vessel is a first vessel configured to receive the single stream of the mixture from the absorption column and separate the mixture into gas and liquid, and wherein the post-absorption column processing assembly further comprises a second vessel configured to receive the gas from the first vessel and remove liquid therefrom.

Embodiment 10: A system, including an absorption column configured to receive a lean solvent and an input gas with a feed gas or a feed vapor therein and induce co-current flow of the lean solvent and the input gas therethrough to form a mixture of a rich solvent with the feed gas or the feed vapor absorbed therein and the input gas with the feed gas or the feed vapor at least partially removed, a post-absorption column processing assembly disposed downstream of the absorption column, a stripper column disposed downstream of the post-absorption column and at least a reboiler, a condenser, and a reflux drum connected to the stripper column, the stripper column, the reboiler, the condenser, and the reflux drum configured to separate rich solvent received from the post-absorption column processing assembly into lean solvent and the compound, and a solvent tank disposed downstream of the stripper column and configured to feed the lean solvent to the absorption column, wherein the post-absorption column processing assembly comprises at least one vessel configured to receive i) at least a single stream of the mixture from the absorption column and separate the mixture into gas and liquid, ii) a first stream with a predominantly liquid phase of the mixture from the absorption column and separate gas therefrom, or iii) a second stream of a predominantly gaseous phase of the mixture and separate the liquid therefrom.

Embodiment 11: The system as in any prior embodiment, wherein the absorption column comprises a corrugated screen packing assembly.

Embodiment 12: The system as in any prior embodiment, wherein the vessel is a first vessel configured to receive the predominantly liquid phase of the mixture from the absorption column and separate the predominantly liquid phase of the mixture into liquid and gas, and wherein the post-absorption column processing assembly further comprises a second vessel configured to receive the predominantly gaseous phase of the mixture and separate the predominantly gaseous phase of the mixture into gas and liquid.

Embodiment 13: The system as in any prior embodiment, wherein the first vessel is configured to feed the liquid separated from the predominantly liquid phase of the mixture to the stripper column and feed the gas separated from the predominantly liquid phase of the mixture to the second vessel, and wherein the second vessel is configured to feed the liquid separated from the predominantly gaseous phase of the mixture to the stripper column.

Embodiment 14: The system as in any prior embodiment, wherein the second vessel is configured to exhaust the gas separated from the predominantly gaseous phase of the mixture.

Embodiment 15: The system as in any prior embodiment, wherein each of the first vessel and the second vessel comprises a housing, an inlet formed in the housing, a mesh layer, a gas outlet, and a liquid outlet.

Embodiment 16: The system as in any prior embodiment, wherein the second vessel is configured to receive the gas separated from the predominantly liquid phase of the mixture, and further separate the gas into liquid and gas.

Embodiment 17: The system as in any prior embodiment, wherein the absorption column includes a regenerative froth contactor.

Embodiment 18: The system as in any prior embodiment, wherein the vessel is a first vessel configured to receive the single stream of the mixture from the absorption column and separate the mixture into gas and liquid, and wherein the post-absorption column processing assembly further comprises a second vessel configured to receive the gas from the first vessel and remove liquid therefrom.

Embodiment 18: A method for operating a system, including feeding a lean solvent and input gas comprising a compound into an absorption column of the system, inducing co-current flow of the lean solvent and the input gas through the absorption column to form a mixture of rich solvent with the compound absorbed therein and the input gas with the compound at least partially removed, the post-absorption column processing assembly comprises at least one vessel configured to receive i) at least a single stream of the mixture from the absorption column and separate the mixture into gas and liquid, ii) a first stream with a predominantly liquid phase of the mixture from the absorption column and separate gas therefrom, or iii) a second stream of a predominantly gaseous phase of the mixture and separate the liquid therefrom, feed into a first vessel the mixture or a predominantly liquid phase of the mixture to separate the mixture or the predominantly liquid phase into liquid and gas, and feed the liquid from the first vessel into a stripper column of the carbon capture system and feed the gas from the first vessel into the second vessel.

Embodiment 20: The method as in any prior embodiment, wherein the absorption column includes a regenerative froth contactor.

All ranges disclosed herein are inclusive of the endpoints, and the endpoints are independently combinable with each other. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system, comprising:
an absorption column configured to receive a lean solvent and an input gas with a feed gas or a feed vapor therein and induce co-current flow of the lean solvent and the input gas therethrough to form a mixture of a rich solvent with the feed gas or the feed vapor absorbed therein and the input gas with the feed gas or the feed vapor at least partially removed; and
a post-absorption column processing assembly disposed downstream of the absorption column,
wherein the post-absorption column processing assembly comprises at least one vessel configured to receive i) at least a single stream of the mixture from the absorption column and separate the mixture into gas and liquid, ii) a first stream with a predominantly liquid phase of the mixture from the absorption column and separate gas therefrom, or iii) a second stream of a predominantly gaseous phase of the mixture and separate the liquid therefrom.

2. The system of claim 1, wherein the absorption column comprises a corrugated screen packing assembly.

3. The system of claim 1,
wherein the vessel is a first vessel configured to receive the predominantly liquid phase of the mixture from the absorption column and separate the predominantly liquid phase of the mixture into liquid and gas, and
wherein the post-absorption column processing assembly further comprises a second vessel configured to receive the predominantly gaseous phase of the mixture and separate the predominantly gaseous phase of the mixture into gas and liquid.

4. The system of claim 3,
wherein the first vessel is configured to feed the liquid separated from the predominantly liquid phase of the mixture to a stripper column and feed the gas separated from the predominantly liquid phase of the mixture to the second vessel, and
wherein the second vessel is configured to feed the liquid separated from the predominantly gaseous phase of the mixture to the stripper column.

5. The system of claim 1, wherein the absorption column includes a regenerative froth contactor.

6. The system of claim 3, wherein each of the first vessel and the second vessel comprises:
a housing,
an inlet formed in the housing,
a mesh layer,
a gas outlet, and
a liquid outlet.

7. The system of claim 4, wherein the second vessel is configured to receive the gas separated from the predominantly liquid phase of the mixture, and further separate the gas into liquid and gas.

8. The system of claim 7, wherein the second vessel is configured to feed the liquid separated from the gas separated from the predominantly liquid gas to the stripper column.

9. The system of claim 1,
wherein the vessel is a first vessel configured to receive the single stream of the mixture from the absorption column and separate the mixture into gas and liquid, and
wherein the post-absorption column processing assembly further comprises a second vessel configured to receive the gas from the first vessel and remove liquid therefrom.

10. A system, comprising:
an absorption column configured to receive a lean solvent and an input gas with a feed gas or a feed vapor therein and induce co-current flow of the lean solvent and the input gas therethrough to form a mixture of a rich solvent with the feed gas or the feed vapor absorbed therein and the input gas with the feed gas or the feed vapor at least partially removed;
a post-absorption column processing assembly disposed downstream of the absorption column;
a stripper column disposed downstream of the post-absorption column and at least a reboiler, a condenser, and a reflux drum connected to the stripper column, the stripper column, the reboiler, the condenser, and the reflux drum configured to separate rich solvent received from the post-absorption column processing assembly into lean solvent and the compound; and
a solvent tank disposed downstream of the stripper column and configured to feed the lean solvent to the absorption column,
wherein the post-absorption column processing assembly comprises at least one vessel configured to receive i) a single stream of the mixture from the absorption column and separate the mixture into gas and liquid, ii) a first stream with a predominantly liquid phase of the mixture from the absorption column and separate gas therefrom, or iii) a second stream of a predominantly gaseous phase of the mixture and separate the liquid therefrom.

11. The system of claim 10, wherein the absorption column comprises a corrugated screen packing assembly.

12. The system of claim 10,
wherein the vessel is a first vessel configured to receive the predominantly liquid phase of the mixture from the absorption column and separate the predominantly liquid phase of the mixture into liquid and gas, and
wherein the post-absorption column processing assembly further comprises a second vessel configured to receive the predominantly gaseous phase of the mixture and separate the predominantly gaseous phase of the mixture into gas and liquid.

13. The system of claim 12,
wherein the first vessel is configured to feed the liquid separated from the predominantly liquid phase of the mixture to the stripper column and feed the gas separated from the predominantly liquid phase of the mixture to the second vessel, and
wherein the second vessel is configured to feed the liquid separated from the predominantly gaseous phase of the mixture to the stripper column.

14. The system of claim 13, wherein the second vessel is configured to exhaust the gas separated from the predominantly gaseous phase of the mixture.

15. The system of claim 12, wherein each of the first vessel and the second vessel comprises:
a housing,
an inlet formed in the housing,
a mesh layer,
a gas outlet, and
a liquid outlet.

16. The system of claim 13, wherein the second vessel is configured to receive the gas separated from the predominantly liquid phase of the mixture, and further separate the gas into liquid and gas.

17. The system of claim 10, wherein the absorption column includes a regenerative froth contactor.

18. The system of claim 10,
wherein the vessel is a first vessel configured to receive the single stream of the mixture from the absorption column and separate the mixture into gas and liquid, and
wherein the post-absorption column processing assembly further comprises a second vessel configured to receive the gas from the first vessel and remove liquid therefrom.

19. A method for operating a system, comprising:
feeding a lean solvent and input gas comprising a compound into an absorption column of the system;
inducing co-current flow of the lean solvent and the input gas through the absorption column to form a mixture of rich solvent with the compound absorbed therein and the input gas with the compound at least partially removed;
the post-absorption column processing assembly comprises at least one vessel configured to receive i) a single stream of the mixture from the absorption column and separate the mixture into gas and liquid, ii) a first stream with a predominantly liquid phase of the mixture from the absorption column and separate gas therefrom, or iii) a second stream of a predominantly gaseous phase of the mixture and separate the liquid therefrom;
feed into a first vessel the mixture or a predominantly liquid phase of the mixture to separate the mixture or the predominantly liquid phase into liquid and gas; and
feed the liquid from the first vessel into a stripper column of the carbon capture system and feed the gas from the first vessel into the second vessel.

20. The method of claim 19, wherein the absorption column includes a regenerative froth contactor.
